(19) United States
(12) Patent Application Publication
(10) Pub. No.: US 2003/0167194 A1
(43) Pub. Date: Sep. 4, 2003

(54) Apparatus and method for generating a process definition

(76) Inventor: Giacomo Piccinelli, Bristol (GB)

Correspondence Address: HEWLETT-PACKARD COMPANY, Intellectual Property Administration, P.O. Box 272400, Fort Collins, CO, 80527-2400, US

(21) Appl. No.: 10/374,618

(22) Filed: Feb. 25, 2003

(30) Foreign Application Priority Data
Feb. 26, 2002 (GB) 0204432.9

(51) Int. Cl. H04L 9/00; H04K 1/00; G06F 17/60

(52) U.S. Cl. 705/7; 705/64

(57) ABSTRACT

Computer apparatus for generating a process definition for execution by a process management system comprising a processor for generating a sequence of activities using information associated with messages exchanged between at least two business entities as part of a business process, wherein the sequence of activities correspond to the business process.

### TECHNICAL FIELD

The present invention relates to an apparatus and method for generating a process definition.

### BACKGROUND

To achieve increased levels of quality, throughput and service at reduced costs individuals and companies are placing an increasing emphasis on automation and computer controlled processes.

In particular, workflow systems (i.e. process management packages) are particularly useful for controlling processes that are definable and governed by a series of policies and procedures, for example insurance claim processing, mortgage loan processing and engineering change orders. Accordingly, the use of workflow systems is increasing in popularity.

Workflow systems are based on procedure definitions that define which process activities must be performed and the sequence in which the activities must be performed.

The procedure is defined using activity nodes connected via arcs, which represent activities of a process. Examples of activity node types are work nodes that typically perform, or initiate, a service and route nodes that are used to define the routing within the process. The activity nodes may incorporate rules that define entry conditions for the activity node and exit conditions that need to be checked after the activity node is completed.

Ideally all activities of a company should be derivable from the execution of business process carefully designed a priori with a suitable process definition.

Unfortunately, however, in practice a large number of aspects associated with businesses activities that are essential for a business solution escape a process-based formalisation.

It is desirable to improve this situation.

### SUMMARY OF THE INVENTION

In accordance with a first aspect of the present invention there is provided a computer apparatus for generating a process definition for execution by a process management system comprising a processor for generating a sequence of activities using information associated with messages exchanged between at least two business entities as part of a business process, wherein the sequence of activities correspond to the business process.

Preferably the computer apparatus further comprising means for monitoring messages exchanged between the at least two business entities.

Preferably the information used by the processor being the time the messages are sent or received by a business entity.

Preferably the information used by the processor being the sender or receiver of the messages.

Preferably at least one or more of the messages have meta-data associated with the messages that are used by the processor for generating the sequence of activities.

Preferably the meta-data includes a protection level assigned to the message.

In accordance with a second aspect of the present invention there is provided a method for generating a process definition for execution by a process management system comprising generating a sequence of activities using information associated with electronic messages exchanged between at least two business entities as part of a business process, wherein the sequence of activities correspond to the business process.

### BRIEF DESCRIPTION OF THE DRAWINGS

For a better understanding of the present invention and to understand how the same may be brought into effect reference will now be made, by way of example only, to the accompanying drawings, in which:

FIG. 1 illustrates a system in accordance with an embodiment of the present invention;

FIG. 2 illustrates a system in accordance with an embodiment of the present invention;

FIG. 3 illustrates an embodiment of a message structure suitable use in an embodiment of the present invention;

FIG. 4 illustrates a system accordance with an embodiment of the present invention;

FIG. 5 illustrates a process definition.

### DETAILED DESCRIPTION OF AN EMBODIMENT OF THE INVENTION

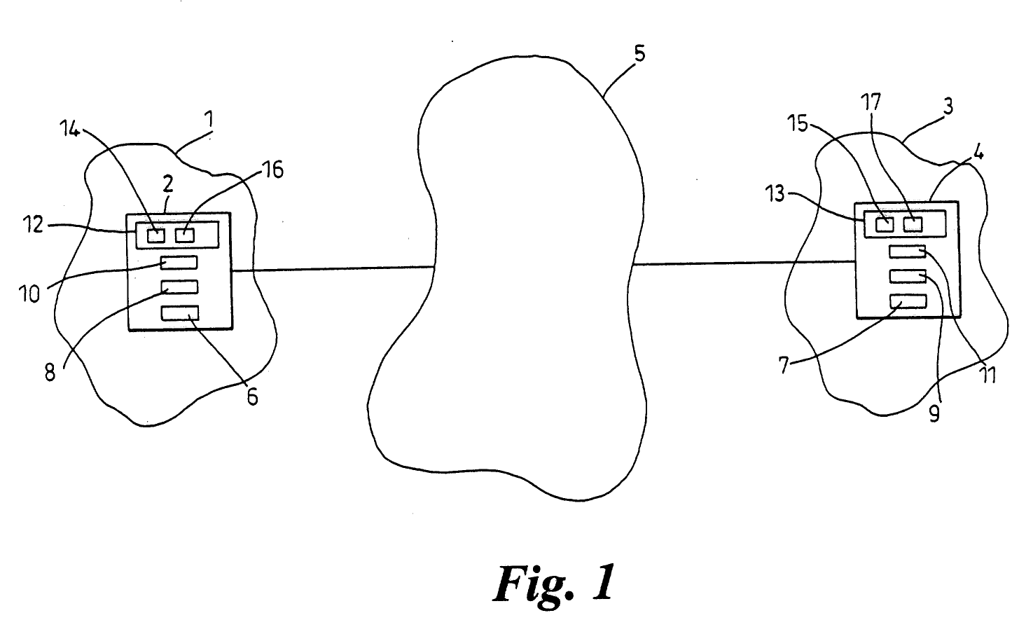

FIG. 1 shows a first business entity 1 having a first computer apparatus 2 and a second business entity 3 having a second computer apparatus 4. The first computer apparatus 2 and second computer apparatus 4 are coupled via a network 5, for example the Internet, thereby allowing a communication link to be established between the first business entity 1 and the second business entity 3.

The first computer apparatus 2 and second computer apparatus 4 are both conventional computers, as is well known to a person skilled in the art. Each computer apparatus includes a processor 6, 7 that communicates with other elements of the computer apparatus over a system bus (not shown). A keyboard 8, 9 is included to allow data to be input into the computer apparatus. A graphics display 10, 11 provides for graphics and text output to be viewed by a user of the computer apparatus. A memory 12, 13 stores an operating system 14, 15; application programs, such as an electronic mail system 16, 17, and other data used by the computer apparatus.

The computer apparatus's 2, 4 are arranged to provide computing facilities to their respective business entity 1, 2, for example in addition to the electronic mail system the computer apparatus's could include a word processor package (not shown) to allow the creation of work reports, specifications, etc.

It should be noted that a business entity will typically have a plurality of computer apparatus's, having different users, that communicate over an internal network, however, for the purpose of this embodiment the first business entity 1 and second business entity 3 each only utilise a single computer apparatus 2, 4, as described above.

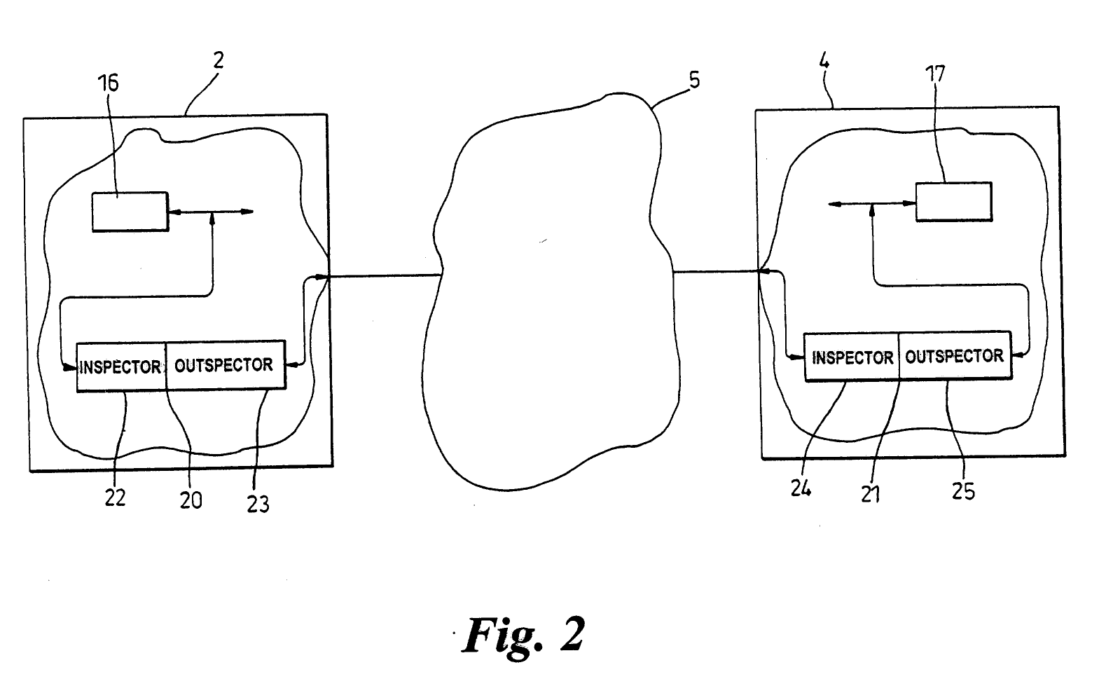

As shown in FIG. 2, each computer apparatus 2,4 includes a filter module 20,21, executed on the processor 6, 7, that intercepts and monitors messages exchanged between the first computer apparatus 2 and the second computer apparatus 4, as described below. Each filter 20, 21 has two functional units—inspector 22, 24 and outspector 23,25. For the purposes of this embodiment the filter module 20, 21 is an application program executed on the processor 6, 7. However, any suitable means for implementing the filter module can be used, for example a stand-alone hardware device.

The following implementation is based upon the first business entity 1 executing a business process, for example the maintenance of supplies, where the business process requires interaction with the second business entity 3 to execute specific business process activities that form part of the first business entities business process, for example the placing of orders with a supplier.

To allow the business process to progress business messages are exchanged between the first business entity 1 and the second business entity 3. The business messages may include, for example process instructions and/or authorisation.

A user of computer apparatus 2 initiates the transfer of a business message using the electronic mail system 16 to generate and transfer the message. Additionally, the user may attach documents, for example product specifications, to the message. The attached documents are typically files encoded in the native format of the application from which the document has been derived.

The messages are wrapped into MIME packages, that form a multipart MIME package, that are transmitted between the business units using the HTTP protocol; in particular the MIME package is packaged into a HTTP POST message and then transferred via the TCP/IP protocol, as is well known in the art. However, any suitable messaging system may be used.

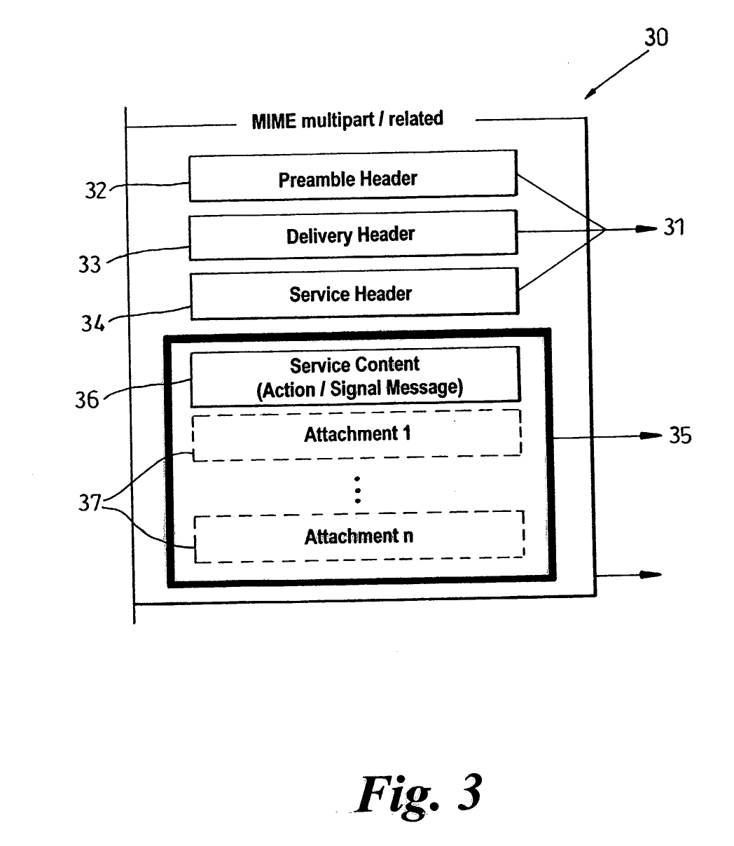

FIG. 3 illustrates a typical business message 30 that is formed as a multipart MIME package. A header 31 comprises a preamble header 32, a delivery header 33 and a service header 34. The headers are sets of meta-data used by applications at different levels in order to understand how to treat he core of the message without having to look at the contents of the message. A payload 35 includes a message 36 with attachments 37.

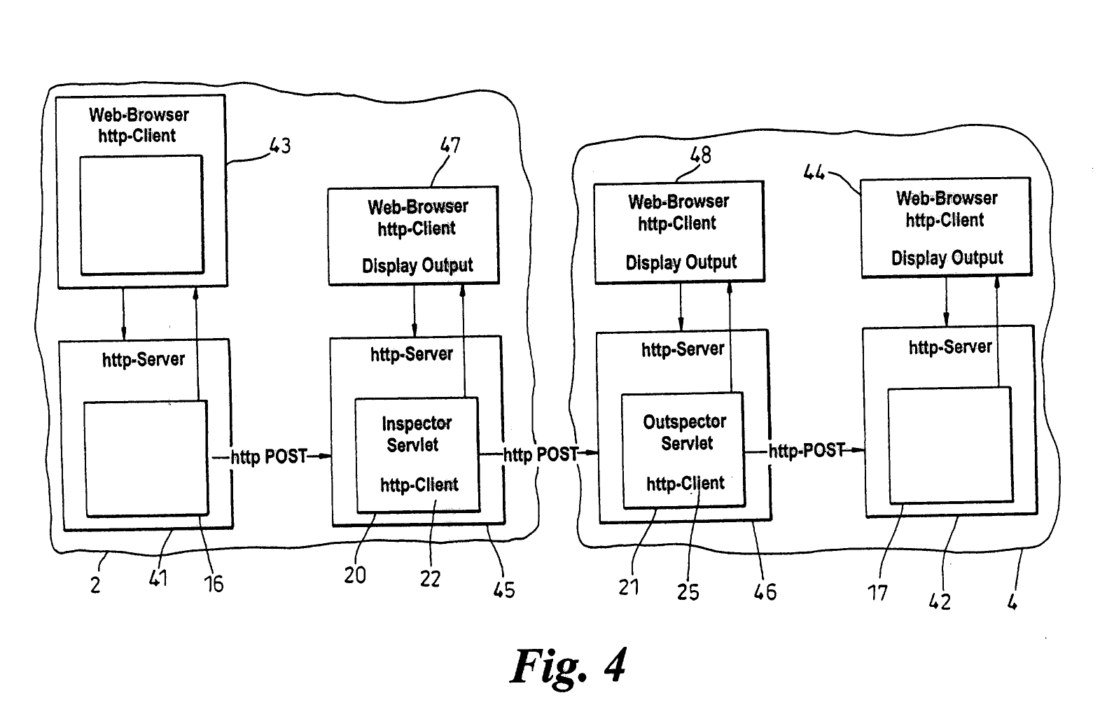

To allow each filter 20, 21 to monitor business messages generated by the electronic mail systems each filter 20, 21 is configured as part of a HTTP server, where the filters act as HTTP clients, as shown in FIG. 4.

Also as shown in FIG. 4, each electronic mail system application 16, 17, which is used to generate and receive the business messages, is run within a separate HTTP server 41, 42. Each HTTP server 41, 42 interacts with a respective web browser 43, 44 installed on the respective computer apparatus 2, 4, thereby allowing a user to read electronic messages generated and received by the electronic mail system applications 16, 17 using the web browser 43, 44. Additionally, the web browser 43, 44 can be utilised as the front end of the electronic mail system 16, 17, thereby allowing the user to use the web browser 43, 44 to generate, for example, the text of a message to be transmitted, and the destination address of the message.

As each filter 20, 21 is configured as part of a HTTP server 45, 46 this allows the filters 20, 21 to intercept the HTTP POST messages generated by the respective electronic mail system 16, 17 using CGI program calls. As each filter 20, 21 is configured within a HTTP server 45, 46 the CGI programs can be developed as Java servlets that can be seen as J2EE Web components. Alternatively, the HTTP servers 45, 46 can be application servers that receive the messages as CGI calls and make the content available to the filters respective inspector and outspector servlets.

The HTTP server 45, 46 are configured to provide the filter 20, 21 with all the functionality needed to read message header information generated by the filters respective electronic mail system 16, 17, retrieve the contained business message MIME package and generate a HTTP response for transmission to the respective electronic mail system and forward the message to the intended addressee. Additionally, the filters can be configured to intercept messages received from the other business unit, as described below.

Optionally, to allow monitoring of the status of the filters 20, 21 a web-browser 47, 48, acting as an http-client, is associated with each respective filter 20, 21. The web browser 47, 48 allows the output of filter data to be displayed to a user. Therefore the filters 20, 21 accept two different calls. The POST calls are for transmission of the business message stream; GET calls are used to connect the standard output stream of the filter to the response stream of the GET call, which is displayed by the calling web-browser 47, 48.

On receipt of incoming business messages received by the filters 20, 21 from the filters respective electronic mail system 16, 17 the received business messages are parsed into an internal object representation. That is to say, the multipart MIME package, that forms the business message, is separated and the separate parts are dispatched to different objects, where the separate parts, in the above example of a multipart MIME package, as shown in figure. 3, would be the preamble header 32, delivery header 33, service header 34, service content 36 and attachments 37.

Typically the body of the MIME package parts, other than the attachments, will be in XML format. If so, the XML bodies can be parsed into a DOM object structure to allow easy access to specific values within these parts. Typically the attachment will be represented as byte arrays.

Once the business message has been parsed the message is analysed. Additionally, in the parsed form the business message can be modified, for example for compression or decompression as described below.

On completion of the analysis, and if applicable modification, of the business message the message MIME package can be reassembled for forwarding to the intended addressee.

The handling of the business message, as described above, is performed by the filter's inspector functional unit 22, 24.

Correspondingly, on receipt by computer apparatus 2, 4 of a business message generated by the other computer apparatus, received over network 5, the business message is intercepted by the computer apparatus's filter 20, 21 and parsed into an internal object representation, as described above.

Once the received business message has been parsed the message can be analysed. Additionally, in the parsed form the business message can be modified, for example for compression or decompression as described below.

On completion of the analysis, and if applicable modification, of the business message the message MIME package can be reassembled for forwarding to the respective electronic mail system 16, 17 for accessing by the user.

The handling of a business message that has been received over the network 5, from the other computer apparatus, is performed by the filter's outspector functional unit 23, 25.

Analysis of business messages transmitted and received, as described above, allows the filters 20, 21 to develop a knowledge base of the information sent and received between the business entities 1, 2. Consequently, new information to be exchanged between the business entities can be exchanged in the form of variations of existing data, as described below.

Accordingly, using knowledge that a given version of a document has been exchanged in the past (sent or received) enables a new version of the document to be reduced to the sending of changes with respect to the previous version.

As the current embodiment only includes two business entities 1, 3 it can be assumed that if one document has been send out in the past this document can be used as a base for the delta compression in successive transmissions of the same (possibly changed) file. However, for configurations that involve additional business entities (not shown) it would be desirable to include functionality to determine from the business message content and from the current process state and history, which file can be used as the base for the delta compression of specific attachments.

If the filter's inspector functional unit 22, 24 detects that an attached file of a business massage has been sent before, for example if the MIME header field Content-ID is used as a unique identifier for a document where the Content-ID doesn't change for successive Versions of that file, then the delta of the current file can be calculated and sent instead of the changed file.

Various techniques can be used for dealing with incremental changes applied to documents, for example format-aware algorithms can be devised for specific data formats and document structures. Given two related documents X and X*, standard comparison techniques can be applied to X and X*'s binary representations. As a result, a compact representation of the transformation to be applied to X in order to become an exact copy of X* can be determined.

If an attachment has not been sent before, the file is saved under the name of its Content-ID, so that it is available for the delta compression of later transmitted file versions.

On receiving a business message over the network the filter's outspector functional unit 23, 25 is configured to recognise if a file with the given Content-ID has been transmitted before. If so, the outspector functional unit 23, 25 will consider the attachment as a delta file that has to be used as a patch to the previously saved base file and recreate the new version by applying the changes. It should be noted that the correct information is always made available at application level, with neither the sender nor recipient of the business message being aware that only changes to a previous document are transmitted with the relevant business message.

For example, business entity 1 may want to place an order for a product based on the specification document previously received from business entity 3. From a business perspective business entity 1 may need to enclose a copy of the entire product specification with indications of the customisation required (e.g. colour or type of material). From a technical perspective, the new specification can be reconstructed by business entity 3 based on the few changes made to the original document. Accordingly, the filter's inspector functional unit 22 associated with business entity 1 identifies that the document attached to a message is a derivative of a previously received document and calculates the differences between the two documents. The inspector unit 22 then forwards to business entity 3 the message with a file containing the differences between the two documents. On receipt of the message by business entity 3 the associated filter's outspector functional unit 25 identifies the initial version of the document to which the changes relate and recreates the new document version before making the new document available to a user.

In addition to allowing bandwidth requirements to be reduced between business entities involved in implementing a business process, the information obtained by the filter 20, 21 on analysing the messages communicated between business entities can be used to determine the process activities involved in a given process, thereby allowing a process definition to be derived for execution in a workflow system. This would ideally be by reconstructing on the fly an a-posterior description of the interaction processes between any given business entities with information derived from new messages being used to monotonically extend the process definition.

Different information models can be used to obtain information on the business process interaction pattern from the analysis of messages exchanged as part of a business process, where the required information can typically be extracted from the message headers. Examples of information model characteristics that can be used to determine a set of process activities are: aggregation of data, process structuring of data and flow prediction.

For example, data aggregation could include two levels, where the first level of aggregation is based on the set of business partners involved. Typically one-to-one interaction is the most common form of business interaction, however multiparty interaction can also be important. As stated above, information on the business partners involved in a message can be extracted from the headers of a message. The second level of aggregation could be identifying the business transaction to which the message is related as different parts of a company may use different processes and systems. Typically some form of identification for business transactions is present in business communication. For example, the message confirming the payment of an invoice contains indications on order number, invoice number, and the indication that the message relates to the financial aspect of a transaction.

Process structure can be based on causal and temporal dependencies.

Temporal dependencies can be modelled using time intervals, where information on the time at which a message is sent or received can be derived from transport metadata (i.e. data associated with a message). So that, for example, all messages observed in a given time interval can be consider part of parallel threads, unless some causal dependencies can be identified. Consequently, messages observed in distinct time intervals can be assumed to be sequential in nature.

Causal dependences can be established based on a message type and knowledge of different types of message flows. For example, a knowledge base can be compiled that can be used to specify general rules. For example, a general rule can state that a payment message is followed by an acknowledgment of a given type. The level of information associated with messages that can be derived using the filter 20, 21 can allow a set of rules to be inserted in the knowledge base.

Flow prediction can be useful in the optimisation of a process definition. Where the objective of prediction techniques is to indicate likely developments for an interaction process, where multiple possibilities can be explored at the same time. The information on the actual development observed for the process contributes to the continuous refinement of the statistical component of the knowledge base used for the predictions.

An example of flow prediction techniques would be pattern-matching techniques to process branches, where the order of application goes from the most recent leaves towards the root. Additionally, matches from the static knowledge base should have precedence over statistical information.

The process activities established from the analysis of the flow of business messages can be used to form a process definition for execution by a workflow system (not shown). The granularity of the process definition derived from the above technique depends in part on the richness of the metadata associated with the business messages, where metadata associated with time of message, sender and receiver can be of particular importance.

By way of example, table 1 below illustrates a simple database of metadata associated with five messages generated from a business process being implemented by business entity A (not shown).

TABLE 1

| Time Interval | Sender | Receiver | Message |
|---|---|---|---|
| T1 | A | B | (m1) |
| T2 | A | B | (m2) |
| T2 | B | A | RE:(m2) |
| T2 | A | C | (m3) |
| T3 | A | C | RE:(m3) |

From the table it is possible to determine that five process activities (in this example the transmission of messages) occurred over three time intervals. The duration of the time intervals is selected based upon the process being monitored, where the duration may, for example, be a fraction of a second or alternatively days.

The first process activity occurs in time interval T1, involving the sending of a message m1 from business entity A to business entity B (not shown), this can be written as A2B-m1.

In the next time interval T2 three process activities occur. These are: i) the sending of message m2 from business entity A to business entity B (or A2B-m2); ii) the sending of message RE:(m2) from business entity B to business entity A (or B2A-re:m2); and iii) the sending of message m3 from business entity A to business entity C (not shown) (or A2C-m3). Based on temporal dependencies, as described above, all messages observed in a given time interval can be considered part of parallel threads, unless some causal dependencies can be identified. Accordingly, A2B-m2 and A2C-m3 can be regarded as parallel activities that, as they occur in time interval T2, occur sequentially from A2B-ml. However, as A2B-m2 and B2A-re:m2 have been found to have a causal dependence, in that re:m2 relates to m2, A2B-m2 and B2A-re:m2 can be regarded as occurring sequentially.

In the next time interval T3 a fifth process activity occurs, the sending of message re:m3 from business entity C to business entity A (or C2A-re:m3), which can be regarded as being sequential in nature with regard to A2C-m3 and B2A-re:m2).

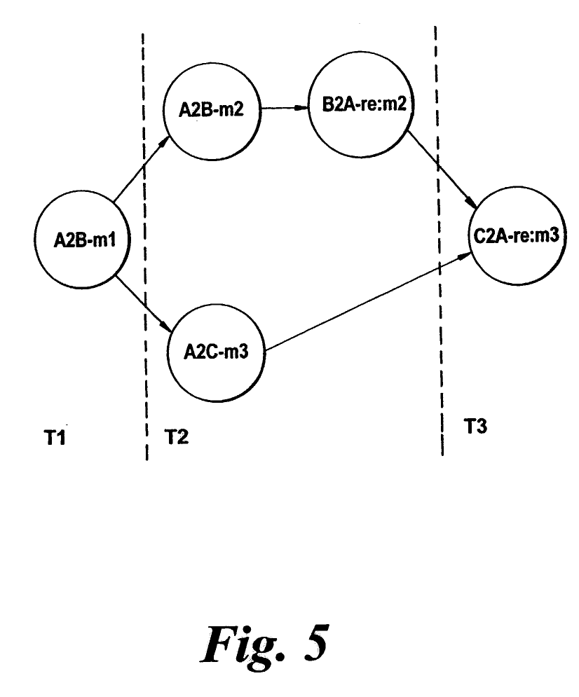

Consequently, the above defines a process definition for the process being executed by business entity A, as shown in FIG. 5, that could be used with a workflow system (not shown) to allow automatic execution of the process, where the activity nodes are connected via arcs.

What is claimed:

1. Computer apparatus for generating a process definition for execution by a process management system comprising a processor for generating a sequence of activities using information associated with messages exchanged between at least two business entities as part of a business process, wherein the sequence of activities correspond to the business process.

2. Computer apparatus according to claim 1, further comprising means for monitoring messages exchanged between the at least two business entities.

3. Computer apparatus according to claim 1, wherein the information used by the processor being the time the messages are sent or received by a business entity.

4. Computer apparatus according to claim 1, wherein the information used by the processor being the sender or receiver of the messages.

5. Computer apparatus according to claim 1, wherein at least one or more of the messages have meta-data associated with the messages that are used by the processor for generating the sequence of activities.

6. Computer apparatus according to claim 5, wherein the meta-data includes a protection level assigned to the message.

7. A method for generating a process definition for execution by a process management system comprising generating a sequence of activities using information associated with electronic messages exchanged between at least two business entities as part of a business process, wherein the sequence of activities correspond to the business process.

8. A method according to claim 7, wherein the information used being the time the messages are sent or received by a business entity.

9. A method according to claim 7, wherein the information used being the sender or receiver of the messages.

10. A method according to claim 7, wherein at least one or more of the messages have meta-data associated with the messages that are used for generating the sequence of activities.

11. A method according to claim 7, wherein the meta-data includes a protection level assigned to the message.
